(19) United States
(12) Patent Application Publication
(10) Pub. No.: US 2006/0050954 A1
(43) Pub. Date: Mar. 9, 2006

(54) Image processing method, computer program product, and image processing apparatus

(75) Inventors: Jun Minakuti, Sakai-shi (JP); Atsushi Ueda, Ritto-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/185,251

(22) Filed: Jul. 20, 2005

(30) Foreign Application Priority Data
Sep. 9, 2004 (JP) JP2004-261861

(51) Int. Cl. G06K 9/00

(52) U.S. Cl. 382/162

(57) ABSTRACT

In an image processing apparatus, raw image data can be read and a tone-converted image obtained by performing γ correction on the raw image data is displayed in an image display area on a display screen. On the image display area, an arbitrary point can be designated by the user. In the case where a first point and a second point are designated, exposure amounts are calculated on the basis of the raw image data, and the exposure amount difference is displayed on an exposure amount difference display area. As a result, the user can grasp the exposure amount difference between the designated points while visually recognizing the tone-converted image. Thus, a proper index used at the time of performing an image process such as γ correction can be obtained.

This application is based on application No. 2004-261861 filed in Japan, the contents of which are hereby incorporated by reference.

### BACKGROUND OF THE INVENTION

1. Field of the Invention

The present invention relates to an image processing technique using image data of a raw image.

2. Description of the Background Art

There is a digital camera (image capturing apparatus) capable of recording an image not only in formats such as a JPEG format and a TIFF format in which an image can be displayed by a general image displaying application but also in a raw data format requiring a unique developing process.

Data in the raw data format is constructed by raw image data photographed and photographing parameters used for developing a raw image. In the case of developing a raw image by the raw image developing application installed in a personal computer or the like, image development (image processing) with photographing parameters different from those at the time of photographing.

By using the raw image data, therefore, parameters such as exposure, white balance, tone conversion, color space and the like can be freely changed after photographing, so that an image suitable for the user can be generated.

One of the techniques using the raw image data is disclosed in “KODAK PROFESSIONAL DCS Photo Desk v4.0” by Eastman Kodak Company, URL: http://www.kodak.com/global/en/professional/products/cameras/photoDesk/photoDesk Main.jhtml (searched online on Aug. 25, 2004). The technique is such that an image obtained by tone-converting raw image data and a histogram based on the raw image data are displayed. The user can obtain accurate brightness information while visually recognizing a tone-converted image properly displayed.

In the above technique, however, although the histogram is displayed together with the image obtained by tone-converting a raw image, the histogram shows only the brightness information of the whole image. Consequently, it is not proper to utilize the histogram as an index at the time of performing an image process such as γ correction on a raw image.

### SUMMARY OF THE INVENTION

The present invention is directed to an image processing method.

According to the present invention, the method includes the steps of (a) obtaining image data of a raw image; (b) performing a tone conversion process regarding a display characteristic of a display part on the raw image to generate a tone-converted image; (c) generating comparison information of exposure amounts of a plurality of image regions designated, on the basis of image data of the raw image; and (d) displaying the tone-converted image and the comparison information of the exposure amounts on the display part. With the method, a proper index used at the time of performing an image process on a raw image can be provided.

In a preferred embodiment of the present invention, in the method, the step (b) includes the step of (b-1) performing a tone conversion process regarding a linear characteristic on the raw image to generate a linear image, and the step (c) includes the step of (c-1) generating the comparison information of the exposure amount on the basis of the linear image. Therefore, comparison information with respect to the exposure amount can be generated promptly.

The present invention is also directed to a computer program product and an image processing apparatus.

Therefore, an object of the present invention is to provide an image processing technique capable of providing a proper index at the time of performing an image process on a raw image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the configuration of a main portion of an image processing apparatus according to an embodiment of the present invention;

FIG. 2 is a diagram showing functional blocks of the image processing apparatus;

FIG. 3 is a diagram illustrating the configuration of an image processing program;

FIG. 4 is a diagram showing a display screen in the case where the image processing program is executed;

FIG. 5 is a flowchart showing processes performed by a tone-converted image generating part;

FIG. 6 is a diagram illustrating a tone conversion characteristic used in the tone-converted image generating part;

FIG. 7 is a diagram illustrating a tone conversion characteristic used in a linear image generating part;

FIG. 8 is a diagram illustrating a pull-down menu;

FIG. 9 is a flowchart showing operation of calculating an exposure amount difference between designated two points;

FIG. 10 is a diagram showing the relation between pixel values of a tone-converted image and a linear image and an exposure amount;

FIG. 11 is a diagram for describing display of the exposure amount difference among a plurality of selected ranges; and

FIG. 12 is a diagram for describing display of the exposure amount difference among a plurality of images as a whole.

### DESCRIPTION OF THE PREFERRED EMBODIMENTS

Configuration of Main Portion of Image Processing Apparatus

FIG. 1 is a schematic diagram showing the configuration of a main portion of an image processing apparatus 1 according to an embodiment of the present invention.

The image processing apparatus 1 takes the form of, for example, a personal computer and has a processing part 10 having a box shape, an operating part 11, and a display 12.

In the front face of the processing part 10, a drive 101 into which an optical disk 91 is inserted and a drive 102 into which a memory card 92 is inserted are provided.

The operating part 11 has a mouse 111 and a keyboard 112 and accepts an operation input to the image processing apparatus 1 from the user.

The display 12 takes the form of, for example, a CRT monitor.

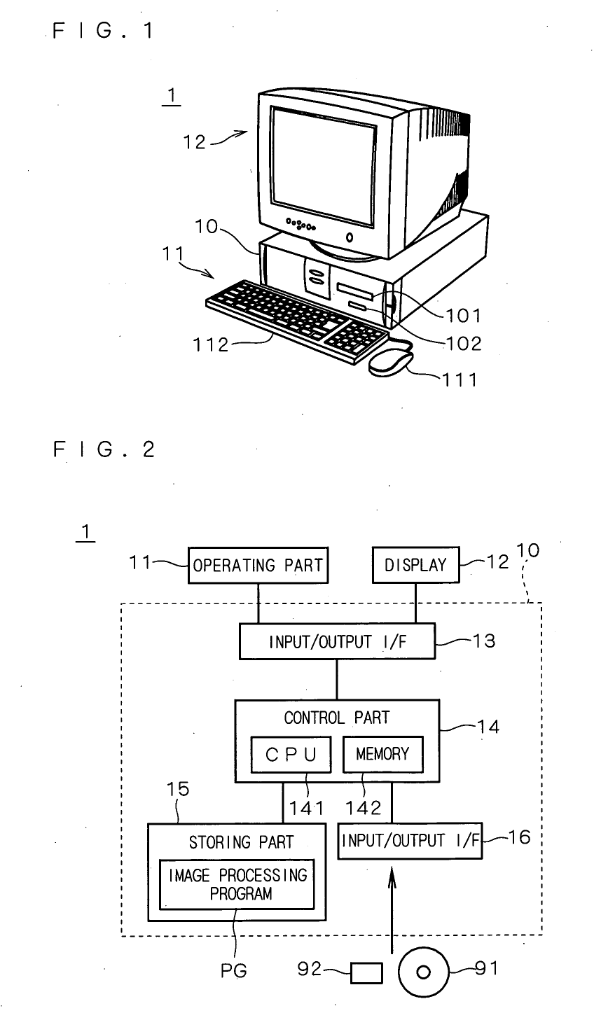

FIG. 2 is a diagram showing functional blocks of the image processing apparatus 1.

The processing part 10 of the image processing apparatus 1 has an input/output I/F 13 connected to the operating part 11 and the display 12, and a control part 14 connected to the input/output I/F 13 so as to be able to send data. The processing part 10 also has a storing part 15 connected to the control part 14 so as to be able to send data and an input I/F 16.

The input/output I/F 13 is an interface for controlling transmission/reception of data among the operating part 11, display 12, and control part 14.

The storing part 15 is constructed as, for example, a hard disk and stores an image processing program PG which will be described later or the like.

The input/output I/F 16 is an interface for inputting/outputting data from/to the optical disk 91 and memory card 92 as recording media via the drives 101 and 102. Via the input/output I/F 16, for example, the image processing apparatus 1 can capture image data of a raw image recorded in the memory card 92.

The raw image data is “raw” image data obtained by digitizing an analog image signal captured by a digital camera having an image capturing device such as a CCD and output as it is from the image capturing device without being subjected to a white balance process or tone conversion. Therefore, the raw image data is faithful information of an exposure amount of a subject. To the raw image data, photographing parameters (photographing information) such as shutter speed and an aperture value are added.

The control part 14 has a CPU 141 functioning as a computer and a memory 142 and is a part for controlling the operations of the image processing apparatus 1 in a centralized manner. By executing the image processing program PG in the storing part 15 by the control part 14, the exposure amount difference can be displayed as will be described later.

Program data such as the image processing program PG recorded on the optical disk 91 can be installed to the memory 142 in the control part 14 via the input/output I/F 16. Consequently, the stored program can be reflected in the operation of the image processing apparatus 1.

Image Processing Program PG

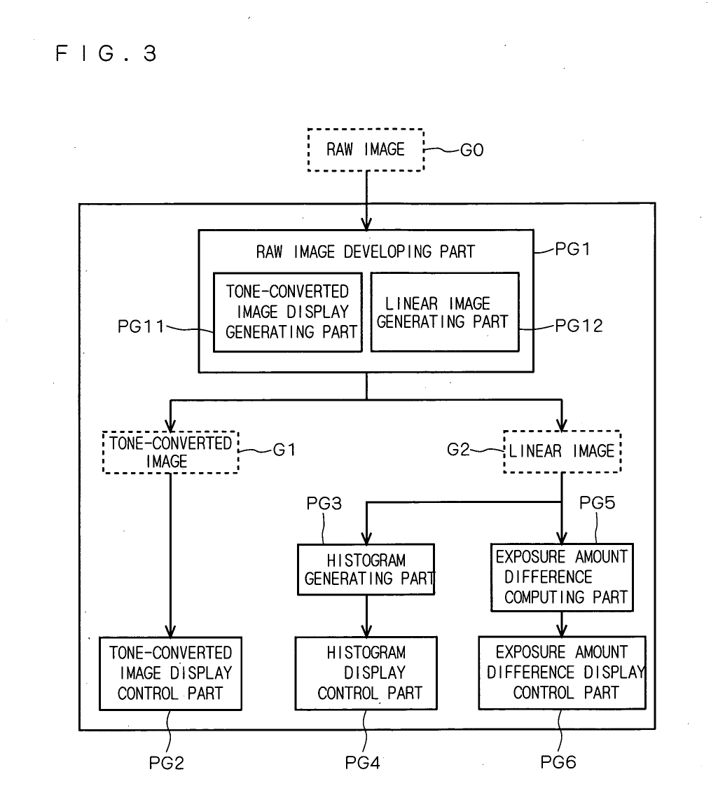

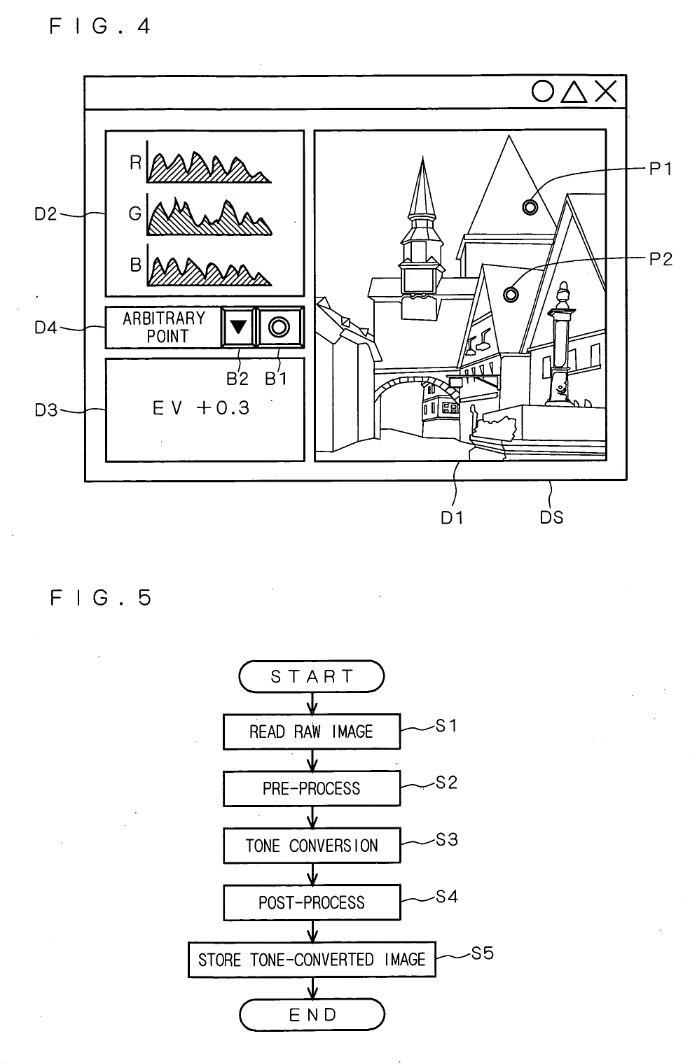

FIG. 3 is a diagram illustrating the structure of the image processing program PG FIG. 4 is a diagram showing a display screen DS in the case where the image processing program PG is executed.

The image processing program PG has a raw image developing part PG1, a tone-converted image display control part PG2, a histogram generating part PG3, a histogram display control part PG4, an exposure amount difference computing part PG5, and an exposure amount difference display control part PG6 functioning as subroutines. Each of the parts functions when executed by the control part 14.

The raw image developing part PG1 has a tone-converted image generating part PG11 for generating a tone-converted image G1 on the basis of a raw image G0 and a linear image generating part PG12 for generating a linear image G2.

First, the process in the tone-converted image generating part PG11 will be described with reference to the flowchart shown in FIG. 5.

For example, the raw image G0 read from the memory card 92 and stored in the memory 142 is read (step S1).

In step S2, pre-processes such as a white balance process and a color interpolation process are performed on the raw image G0 read in step S1.

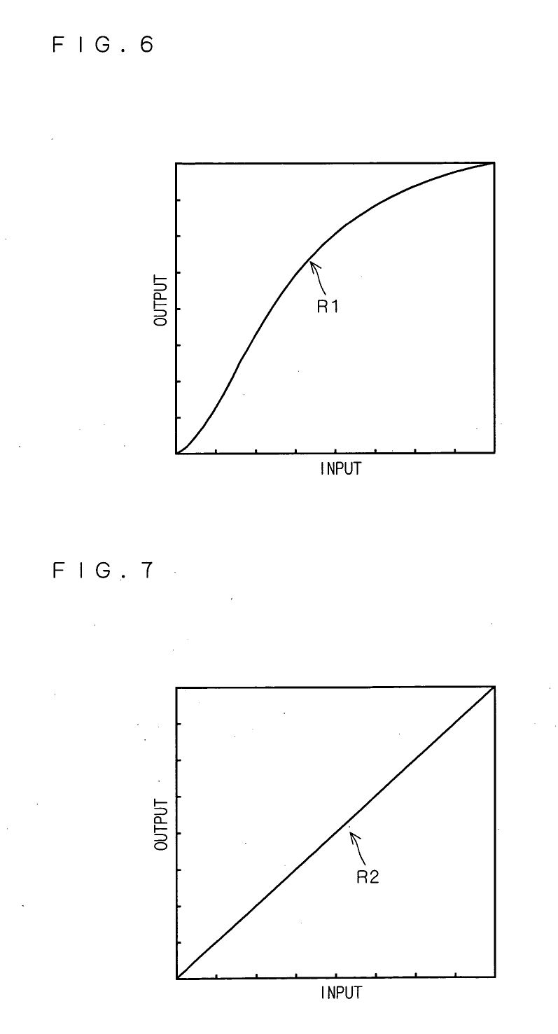

In step S3, a tone converting process corresponding to display characteristics of the display 12 is performed on the image subjected to the pre-processes in step S2. Concretely, tone conversion for monitor display is performed by using a data table in which a tone conversion characteristic R1 shown in FIG. 6, specifically, a γ characteristic for making the contrast of an input image high-keyed is described.

In step S4, a post-process such as a sharpness process is performed on the image which is tone-converted in step S3, thereby generating a tone-converted image G1.

In step S5, the tone-converted image G1 generated in step S4 is stored in the memory 142 of the control part 14.

With respect to processes in the linear image generating part PG12, operations similar to the flowchart shown in FIG. 5 are performed except for the operation in step S3. In step S3, a tone converting process on a raw image is performed by using the data table in which the tone conversion characteristic R2 shown in FIG. 7 such that the relation between the input and the output is linear is described, thereby generating the linear image G2.

Referring again to FIG. 3, description will be continued.

The tone-converted image G1 generated by the tone-converted image generating part PG11 is displayed in an image display area D1 in the display screen DS shown in FIG. 4 by the tone-converted image display control part PG2.

The histogram generating part PG3 reads the linear image G2 in the memory 142 and generates histograms of RGB channels on the basis of the linear image G2. The histograms generated by the histogram generating part PG3 are displayed in a histogram display area D2 shown in FIG. 4 by the histogram display control part PG4.

The exposure amount difference computing part PG5 calculates exposure amounts of two pixels corresponding to a first point P1 and a second point P2 designated on the image display area D1 and computes the difference between the exposure amounts. The user clicks a point designation button B1 shown in FIG. 4 with the mouse 111 and, after that, moves the cursor displayed in the image display area D1 with the mouse 111 to designate the first and second points P1 and P2.

The exposure amount difference between the designated points calculated by the exposure amount difference computing part PG5 is displayed in the exposure amount difference display area D3 shown in FIG. 4 by the exposure amount difference display control part PG6.

By executing the image processing program PG as described above, the tone-converted image G1 obtained by performing the normal γ correction on a raw image which is input to the image processing apparatus 1 and the linear image G2 indicative of the exposure amount are generated. The tone-converted image G1 is displayed in the image display area D1, and a histogram based on the linear image G2 and the exposure amount difference can be displayed.

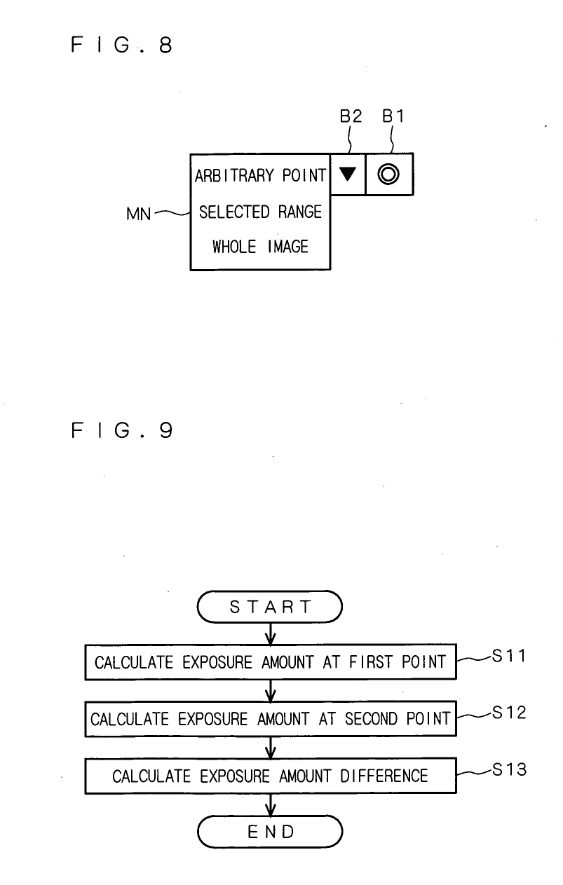

In the image processing apparatus 1, the exposure amount difference among a plurality of points can be displayed as described above. In addition, the exposure amount difference among a plurality of selected ranges designated on the screen and the exposure amount difference among a plurality of whole images can be displayed. Display of the exposure amount difference is switched by clicking the selection button B2 shown in FIG. 4 with the mouse 111 and, after that, selecting any of the items “arbitrary point”, “selected range”, and “whole image” in the pull-down menu MN displayed on the screen as shown in FIG. 8.

In the following, display regarding (1) the exposure amount difference among a plurality of points, (2) the exposure amount difference among a plurality of selected ranges, and (3) the exposure amount difference among a plurality of whole images will be described in order.

Display of Exposure Amount Difference

(1) Exposure Amount Difference Among a Plurality of Points

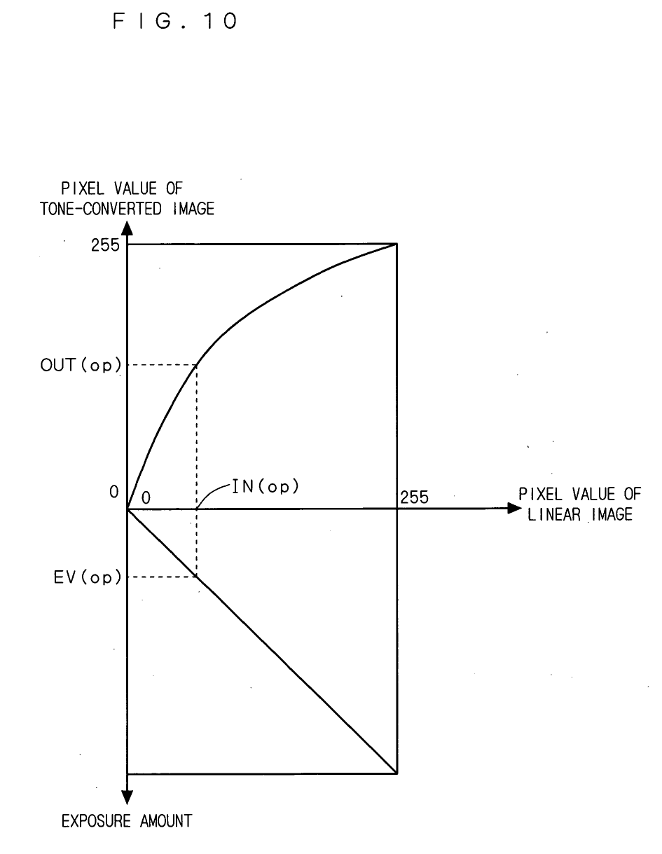

FIG. 9 is a flowchart showing operation of calculating the exposure amount difference between two points designated. The operation is executed by the exposure amount difference computing part PG2.

First, the selection button B2 is clicked and “arbitrary point” in the pull-down menu MN of FIG. 8 is selected (the selection items are displayed in the selection item display area D4 shown in FIG. 4). After that, the point designation button B1 shown in FIG. 4 is clicked and the exposure amount in the first point P1 designated in the image display area D1 is calculated (step S11). The exposure amount calculation will be described in detail.

First, from photographing information such as Exif information regarding the raw image G0 including the first point P1, a reference exposure amount EV(op) is obtained. The reference exposure amount EV(op) is calculated as an APEX value of the raw image on the basis of exposure control value information (such as shutter speed and an aperture value) in the photographing information. By the APEX value, any of elements regarding exposure such as shutter speed, an aperture value, and ISO sensitivity is converted to a logarithm and exposure can be computed by addition/subtraction.

In the case where the shutter speed, the aperture value, and ISO sensitivity converted to the APEX values are set as TV, AV, and SV, respectively, and the APEX value of subject's brightness is set as BV, the exposure amount EV can be expressed by the following equation (1).
EV=AV+TV=BV+SV (1)

By substituting shutter speed TV(op) and aperture value AV(op) obtained as photographing information of the raw image G0 into Equation (1), the reference exposure amount EV(op) of the whole raw image can be calculated.

When the pixel value of the linear image G2 corresponding to the exposure amount EV(op) is set as IN(op) and the pixel value of the tone-converted image G1 is set as OUT(op), the relation of the pixel values is expressed as shown in FIG. 10.

Specifically, the relation between the pixel value of the linear image G2 including IN(op) and the pixel value of the tone-converted image G1 including OUT(op) depends on the tone conversion characteristic R1 (FIG. 6) of a digital camera used for photographing.

On the other hand, the relation between the pixel value of the linear image G2 including IN(op) and the exposure amount including EV(op) is expressed by a linear function as shown in FIG. 10. The exposure amount EV(X) at an arbitrary pixel value X in the linear image G2 can be expressed by the following equation (2).

$$EV ( X ) = \frac{EV ( op )}{IN ( op )} X \qquad ( 2 )$$

Therefore, the exposure amount at the first point P1 arbitrarily designated on the tone-converted image G1 displayed in the image display area D1 can be calculated by substituting the pixel value X of the linear image having the same coordinate value as that of the first point P1 on the tone-converted image G1 into Equation (2).

Referring again to FIG. 9, the description will be continued.

In step S12, the exposure amount at the second point P2 designated in the image display area D1 shown in FIG. 4 is calculated. The exposure amount at the second point P2 is calculated in a manner similar to the calculation of the exposure amount at the first point P1 in step S11.

In step S13, the difference between the exposure amount of the first point P1 calculated in step S11 and the exposure amount of the second point P2 calculated in step S12 is computed, thereby obtaining the exposure amount difference.

The exposure amount difference between the designated points calculated as described above is displayed in the exposure amount difference display area D3 in FIG. 4. Specifically, information of the exposure amount difference (exposure amount comparison information) between a plurality of points (parts of an image) designated in a single image is generated on the basis of the linear image G2 and, after that, the information of the exposure amount difference and the tone-converted image G1 are simultaneously displayed on the display 12.

(2) Exposure Amount Difference Among Plural Selected Ranges

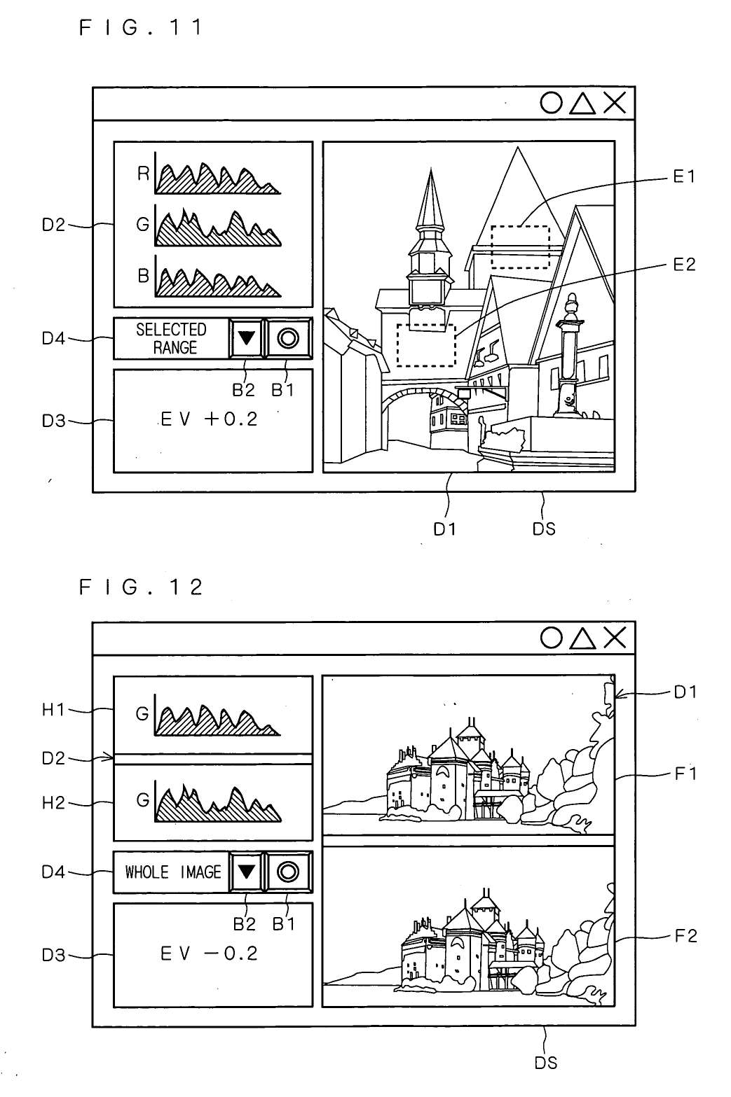

FIG. 11 is a diagram for describing display of an exposure amount difference among a plurality of selected ranges. The diagram corresponds to the display screen DS shown in FIG. 4.

The selection button B2 is clicked and “selected range” in the pull-down menu MN of FIG. 8 is selected (selection items are displayed in the selection display area D4 shown in FIG. 11). After that, the mouse 111 is dragged on the image display area D1 shown in FIG. 11, thereby designating, for example, a first selection range E1 and a second selection range E2.

The total exposure amount of each of the first and second selection ranges E1 and E2 designated as described above is calculated by applying the above-described equation (2) on all of the pixels in the selection range. An average value of the total exposure amount of each of the first and second selection ranges E1 and E2 is calculated and the resultant is used as the exposure amount.

Next, the difference between the average exposure amount of the first selection range E1 and the average exposure amount of the second selection range E2 is calculated, thereby obtaining the exposure amount difference.

The exposure amount difference among the plural selection ranges calculated as described above is displayed in the exposure amount difference display area D3 shown in FIG. 11. Specifically, information of the exposure amount difference among a plurality of image parts designated in a single image is generated on the basis of image data of the raw image G0. After that, the information of the exposure amount difference and the tone-converted image G1 are displayed in parallel in the display 12.

(3) Exposure Amount Difference of Plurality of Whole Images

FIG. 12 is a diagram for describing display of the exposure amount difference among a plurality of whole images. The diagram corresponds to the display screen DS shown in FIG. 4.

The selection button B2 is clicked and “whole image” in the pull-down menu MN of FIG. 8 is selected (selection items are displayed in the selection display area D4 shown in FIG. 12). After that, for example, two images are read and a first image F1 and a second image F2 are displayed in the image display area D1 shown in FIG. 12. In the histogram display area D2, histograms H1 and H2 corresponding to the two images F1 and F2, respectively are displayed as shown in FIG. 12.

The exposure amount EV(op) of each of the whole first image F1 and the whole second image F2 which are read is calculated by using Equation (1) on the basis of the shutter speed and the aperture value of the photographing information given to the raw image data.

Next, the difference between the exposure amount of the whole first image F1 and the exposure amount of the whole second image F2 is calculated, thereby obtaining the exposure amount difference.

The exposure amount difference among a plurality of whole images calculated as described above is displayed in the exposure amount difference display area D3 shown in FIG. 12. Specifically, information of the exposure amount difference among a plurality of whole images designated is generated on the basis of image data of the raw image G0. After that, the information of the exposure amount difference and the tone-converted image G1 are displayed on the display 12.

By the operation of the image processing apparatus 1 as described above, the tone-converted image and also the exposure amount difference among a plurality of image regions designated are displayed. Consequently, a proper index at the time of performing the image process such as γ correction can be provided to the user. By also displaying the histogram, reference information corresponding to an index increases.

In the image processing apparatus 1, it is not essential to calculate an exposure amount at a designated point by using Equation (2). Alternately, an exposure amount (brightness) at each point (x, y) on an image may be calculated by the following method.

In the case where an image of a subject having brightness B is formed on an image capturing face of an image capturing device such as a CCD through an optical system, the illuminance L on the image capturing face can be expressed by the following equation (3).

$$L = B \times \frac{π}{4} \times ρ ( x , y , {f}^{′} , F ) \times \frac{1}{{F}^{2}} \qquad ( 3 )$$

where ρ(x, y, f′, F) denotes transmittance of the optical system in the position corresponding to the coordinate (x, y) of the pixel on the image capturing face and changes according to the focal length f′ of the taking lens and the f number F of the optical system.

When light having the illuminance L is incident, an output value “n” obtained by converting an analog signal from the image capturing device to a digital signal by an A/D converter is expressed by the following equation (4).
n=L×a×T (4)
where “a” denotes a constant determined by the characteristic of the image capturing device, the gain of an amplifier for amplifying an output of the image capturing device, settings of the A/D converter, and the like, and T indicates exposure time. The exposure time T corresponds to integral time of the image capturing device or shutter open time. In a digital camera, generally, the value corresponding to the constant “a” is called sensitivity. Consequently, when the sensitivity is set as S, Equation (4) can be rewritten as the following equation (5).
   n=L×b×S×T (5)

In Equation (5), the sensitivity S is generally converted so as to correspond to the ISO sensitivity value of a silver-halide film in a digital camera, so that the constant for conversion is set as “b”.

The brightness B is calculated from the output value “n” on the basis of Equations (3) and (5) by the following equation (6).

$$B = n \times \frac{1}{ρ ( x , y , {f}^{′} , F )} \times \frac{1}{k \cdot S} \times \frac{{F}^{2}}{T} \qquad ( 6 )$$

where k denotes a constant to organize the constants in Equations (3) and (5).

The constant k and the function p in Equation (6) are internally held by the image processing program PG By substituting the f number F, the shutter speed T, and the image capturing sensitivity S at the time of photographing given to the raw image data and the pixel value of the linear image corresponding to the output value “n” into Equation (6), the brightness value of each pixel is calculated. By using Equation (1), the exposure amount EV is calculated by using BV as the APEX value of the brightness value B.

To prepare the functions p so as to correspond to combinations of coordinates of all of pixels constructing an image, focal lengths, and F numbers, an enormous amount of data is required. Consequently, the function ρ may be derived by interpolating computation on the basis of, for example, a data table expressing the functions ρ in discrete values. Alternately, the constant k and the function ρ may be recorded as photographing data of the digital camera.

By using Equation (6), the exposure amounts at the first and second points can be calculated and the exposure amount difference can be also obtained by subtraction.

Modifications

In the foregoing embodiment, it is not indispensable to display the exposure amount difference between the plural points P1 and P2 on a single image as shown in FIG. 4 but the exposure amount difference between points designated in plural images may be displayed. Alternatively, the exposure amount difference between one or more points designated by the user and a selected area in the same image or another image may be displayed. It is also possible to display the exposure amount difference between one or more points designated by the user and the whole same image or whole another image may be displayed.

In the foregoing embodiment, it is not indispensable to display the exposure amount difference among the plurality of selection ranges E1 and E2 on a single image as shown in FIG. 11 but an exposure amount difference among selection ranges (image parts) designated in plural images may be displayed.

The linear image in the foregoing embodiment is not limited to image data constructed by three colors of R, Q and B but may be image data constructed only by G pixels. If image data of only G color is used for a linear image, no influence is exerted on the G pixels even when a white balance process is performed. Therefore, the image data can be used as image data faithfully expressing brightness of a subject.

As the linear image, a brightness image in the case where Y (brightness) 0.3*Red+0.6*Green+0.1*Blue may be used.

In the foregoing embodiment, it is not essential to display the exposure amount difference but the exposure amounts of the image parts may be displayed in parallel. In this way as well, comparison information of the exposure amounts can be provided.

In the foregoing embodiment, it is not essential to display the exposure amount difference between two image regions. An exposure amount difference among three or more image regions may be also displayed.

While the invention has been shown and described in detail, the foregoing description is in all aspects illustrative and not restrictive. It is therefore understood that numerous modifications and variations can be devised without departing from the scope of the invention.

What is claimed is:

1. An image processing method comprising the steps of:
(a) obtaining image data of a raw image;
(b) performing a tone conversion process regarding a display characteristic of a display part on said raw image to generate a tone-converted image;
(c) generating comparison information of exposure amounts of a plurality of image regions designated, on the basis of image data of said raw image; and
(d) displaying said tone-converted image and said comparison information of said exposure amounts on said display part.

2. The image processing method according to claim 1, wherein
said step (b) includes the step of (b-1) performing a tone conversion process regarding a linear characteristic on said raw image to generate a linear image, and
said step (c) includes the step of (c-1) generating said comparison information of said exposure amount on the basis of said linear image.

3. The image processing method according to claim 1, wherein
a plurality of points in a single image are designated as said plurality of image regions.

4. The image processing method according to claim 1, wherein
a whole single image and one or more points in said whole single image are designated as said plurality of image regions.

5. The image processing method according to claim 1, wherein
respective points of a plurality of images are designated as said plurality of image regions.

6. The image processing method according to claim 1, wherein
a plurality of whole images are designated as said plurality of image regions.

7. The image processing method according to claim 1, wherein
one or more whole images and one or more points in a plurality of images are designated as said plurality of image regions.

8. The image processing method according to claim 1, wherein
a plurality of image parts in a single image or respective image parts of a plurality of images are designated as said plurality of image parts.

9. A computer program product for making a computer execute the steps of:
(a) performing a tone conversion process regarding a display characteristic of a display part on a raw image captured to generate a tone-converted image;
(b) generating comparison information of exposure amounts of a plurality of image regions designated, on the basis of the image data of said raw image; and
(c) displaying said tone-converted image and said comparison information of said exposure amounts on said display part.

10. The computer program product according to claim 9, wherein
said step (a) includes the step of (a-1) performing a tone conversion process regarding a linear characteristic on said raw image to generate a linear image, and
said step (b) includes the step of (b-1) generating said comparison information of said exposure amount on the basis of said linear image.

11. The computer program product according to claim 9, wherein
a plurality of points in a single image are designated as said plurality of image regions.

12. The computer program product according to claim 9, wherein
a whole single image and one or more points in said whole single image are designated as said plurality of image regions.

13. The computer program product according to claim 9, wherein
respective points of a plurality of images are designated as said plurality of image regions.

14. The computer program product according to claim 9, wherein
a plurality of whole images are designated as said plurality of image regions.

15. An image processing apparatus having a display part capable of displaying an image, comprising:
(a) an obtaining part for obtaining image data of a raw image;
(b) an image generator for performing a tone conversion process regarding a display characteristic of said display on said raw image to generate a tone-converted image;
(c) a comparison information generator for generating comparison information of exposure amounts of a plurality of image regions designated, on the basis of image data of said raw image; and
(d) a display controller for displaying said tone-converted image and said comparison information of said exposure amounts on said display part.

16. The image processing apparatus according to claim 15, wherein
said image generator includes (b-1) a part for performing a tone conversion process regarding a linear characteristic on said raw image to generate a linear image, and
said comparison information generator includes (c-1) a part for generating said comparison information of said exposure amount on the basis of said linear image.

17. The image processing apparatus according to claim 15, wherein
a plurality of points in a single image are designated as said plurality of image regions.

18. The image processing apparatus according to claim 15, wherein
a whole single image and one or more points in said whole single image are designated as said plurality of image regions.

19. The image processing apparatus according to claim 15, wherein
respective points of a plurality of images are designated as said plurality of image regions.

20. The image processing apparatus according to claim 15, wherein
a plurality of whole images are designated as said plurality of image regions.
